(19) United States
(12) Patent Application Publication
(10) Pub. No.: US 2005/0049952 A1
(43) Pub. Date: Mar. 3, 2005

(54) Stock selection & indexing systems and methods

(76) Inventor: Kevin Todd Carter, Lafayette, CA (US)

Correspondence Address: LATHROP & GAGE LC, 4845 PEARL EAST CIRCLE, SUITE 300, BOULDER, CO, 80301, US

(21) Appl. No.: 10/917,804

(22) Filed: Aug. 13, 2004

Related U.S. Application Data
(60) Provisional application No. 60/494,974, filed on Aug. 14, 2003.

(51) Int. Cl. G06F 17/60

(52) U.S. Cl. 705/36

(57) ABSTRACT

A system, method and software product describe a customizable, index-based stock management methodology. This methodology provides for diversification and risk control of indexing combined with individual customization and active tax management. The system employing the methodology permits individual investors to invoke investment processes that track indexes to gain specified market exposure, control risk, and minimize costs while invoking individual preferences, current holdings, or social concerns

### CROSS-REFERENCE TO RELATED APPLICATION

This application claims priority to U.S. Provisional Application Ser. No. 60/494,974, filed Aug. 14, 2003, and incorporated herein by reference.

### BACKGROUND

Individual investors seeking diversification and professional management of their investments have frequently chosen mutual funds as their preferred investment vehicle. Often a small or mid-tier investor would hold a small portfolio of individual securities for speculation or amusement, but would look to mutual funds for long-term growth. Only the wealthiest investors had sufficient assets to build well-diversified portfolios from individual securities or attract the attention of professional money managers.

For many investors, managed accounts are a superior alternative to mutual funds. Two advantages they offer investors are direct ownership of securities and a tax regime in which only the investor's own portfolio determines the investor's tax liability. However, managed accounts require a large investment that is prohibitive to all but the wealthiest investors.

### SUMMARY

In one embodiment, customizable, index-based stock management methodology is provided. This methodology provides for diversification and risk control of indexing combined with individual customization and active tax management. A system employing the methodology permits individual investors to invoke investment processes that track indexes to gain specified market exposure, control risk, and minimize costs while invoking individual preferences, current holdings, or social concerns.

Security selection and indexing systems and methods are provided to allow smaller investors to achieve similar performance of a target index in separately managed accounts. These systems and methods (“active indexing”) provide pre-tax performance similar to those of specific benchmark indexes with a subset of securities. Furthermore, active tax management strategies allow for greater post-tax returns. Active indexing provides similar returns to a target index and the tax management strategies only available to separately managed accounts but without the large investment required by traditional managed accounts.

As an aid to understanding the disclosure herein, the Standard and Poor's 500 Index (S&P 500) is used as an exemplary index in a non-limiting context. Other indexes may be selected as a matter of design choice, such as an investor's preference. For example, an investor may select a health care index, over the S&P 500, in the belief that such an index would be more lucrative than a general market index. The S&P 500 has established categories (“sectors”) within the S&P 500 determined by the Global Industry Classification Standard (“GICS”). If another publicly available index or custom index is used, then a corresponding subdivision of the index into sectors may be made to further distinguish subsections comprising the index. When referring to the S&P 500 exemplary index, individual securities may be referred to as stocks. However, if another index is substituted for the S&P 500, individual securities may be bonds, commodities, futures contracts, or other financial instruments that comprises the selected index.

In one embodiment, a security selection method is provided to achieve similar pre-tax performance of the target index with a subset of the constituent securities. The method may comprise selecting an index, determining the index's sector weights, selecting a target number of securities for the account, and purchasing the securities.

An index is selected based on an investor's preference, existing portfolio, and/or other personal or strategic factors. For example, a belief that the general market is a lucrative investment may lead an investor to select the S&P 500. Next, the index's sector weights are determined. Weighting by market capitalization is one method of determining weights. Other weighting methods may be employed to target a particular segment of the market, for example, earnings ratio, yield, debt-to-equity, market share, or other attribute. Weighting of the index is reflected by the weighting of the sectors within the portfolio. For example, if the S&P 500 energy sector has a market capitalization of $200 billion and the health care segment has a market capitalization of $100 billion, the portfolio would be built with a corresponding capitalization having substantially twice the investment in the energy sector stocks as health care sector. Optionally, an adjustment may be employed to exclude securities or sectors based on, for example, an investors existing portfolio or investment strategy. Adjustment factors provide a custom index that may be created from a publicly available index and modified to suit the investor. As a benefit, an investor who views a particular industry segment as detrimental or lucrative to his portfolio may modify the index. As another benefit, investors that have an existing investment in a given sector may not wish to increase their exposure in that sector and the resulting index may then exclude the given sector. Individual securities may be excluded, as discussed below. Once the sectors and sector weights of an index have been determined, and optionally customized, individual securities are selected.

In another embodiment, methods of selecting securities within a sector is provided. In the embodiment, securities are sorted by market capitalization, from largest to smallest. Categories of securities are then determined based on an investor's preference.

In another embodiment, a division of securities within sector is determined by buckets. As a further embodiment, buckets are market capitalization tranches.

In another embodiment, a target number of securities are selected reflective of an investor's objectives. The investor's preference may be governed by cost of trading large versus small blocks of securities, diversification preferences, or other personal or strategic objectives.

In another embodiment, the number of securities to put into each sector is determined. The number of target securities is preferably larger than the number of sectors in the index. At least one security is put into each sector first, then the number of securities per sector is determined by:
ROUND[(percentage of securities in sector)×(total number of securities desired−number of sectors)]+1.

In another embodiment, an investor may wish to exclude a selected security. As an option the excluded security is omitted. As another option, the target index is customized to exclude the excluded security. As yet another option, a substitute security replaces the excluded security. And as yet another option, additional investment in other selected securities replaces the excluded security.

In another embodiment, an exchange traded fund (“ETF”) is added to a portfolio with a number of securities below a threshold number, such as 50. As a benefit, adding an ETF to a small security-count portfolio may reduce its index tracking error.

In another embodiment, the ETF comprises a reserve, such as 1% of the portfolio, to provide a ready source of liquidity to pay fees and to provide reserve for market fluctuations between the determination of a portfolio to acquire and the actual acquisition cost.

In another embodiment, a percentage of the portfolio is cash, such as 1% to provide a ready source of liquidity to pay fees and to provide reserve for market fluctuations between the determination of a portfolio and the actual acquisition of the portfolio.

As markets fluctuate, a need for rebalancing may arise to keep the portfolio aligned with the target index. In one embodiment, rebalancing is applied to a sector, category, or individual security. If a sector misweight is greater than a misweight threshold, such as 2%-absolute the sector is rebalanced. Using cash from tax-loss harvesting, disclosed below, replacement securities are then selected. The largest underweight sector is rebalanced first by purchasing constituent securities. If a sector is missing a security, the missing security is purchased first according to the initial allocation, disclosed above. For example, if the sector has 9 securities, it would then purchase security number 10 from the next category to be populated. If the sector is not missing any securities, additional shares of existing securities are purchased. Securities in the first category, such as the first tranche, may be purchased according to the initial portfolio setup, such as purchasing tranche 1 securities from largest to smallest and tranches 2, 3, or 4 securities from the next closest to the median. As an option, a replacement method may be selected which is dissimilar to the method used to populate the initial portfolio.

In another embodiment, additional rebalancing occurs repeatedly as needed. Securities at or above the over-weighted threshold are sold and rebalanced but additional rebalancing may be required at the sector level, even though no individual security is overweight. Sector securities are sold to eliminate a sector over-weight.

In another embodiment, tax-loss harvesting is provided. As a security declines in price, upward price potential may still be present. Simultaneously, the owner may wish to realize the lost value of the security for tax purposes. Current tax laws in countries such as the United States prohibit realizing a loss if the same security is purchased 30 days before or after the sale, known as the “Wash Sale Rule.” By repurchasing a similar security, e.g., purchasing Ford after selling General Motors, or purchasing McDonnell Douglas after selling Boeing, a sector's position is rebalanced back to the target index and a tax loss may be realized.

In another embodiment, dividend income is invested in ETF until a threshold, for example 1.5% of the portfolio value, is held in the ETF. Once the ETF threshold is met, securities are purchased according to at least one methodology disclosed herein.

In another embodiment, total portfolio liquidation is provided by selling all securities, ETF, and other non-cash holdings. As an option the account may be closed. In another embodiment, a partial reduction in holdings is executed; as an option, the owner of the account may receive a disbursement of the resulting funds. As a further option, the remaining portfolio is rebalanced.

### BRIEF DESCRIPTION OF ILLUSTRATED EMBODIMENTS

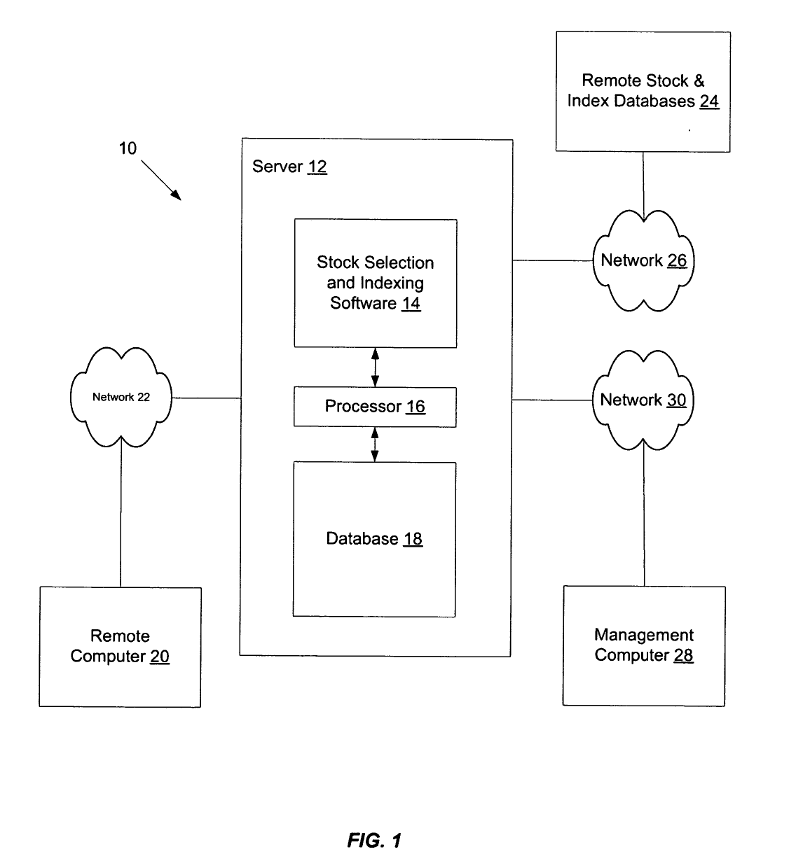

FIG. 1 shows a stock selection and indexing system.

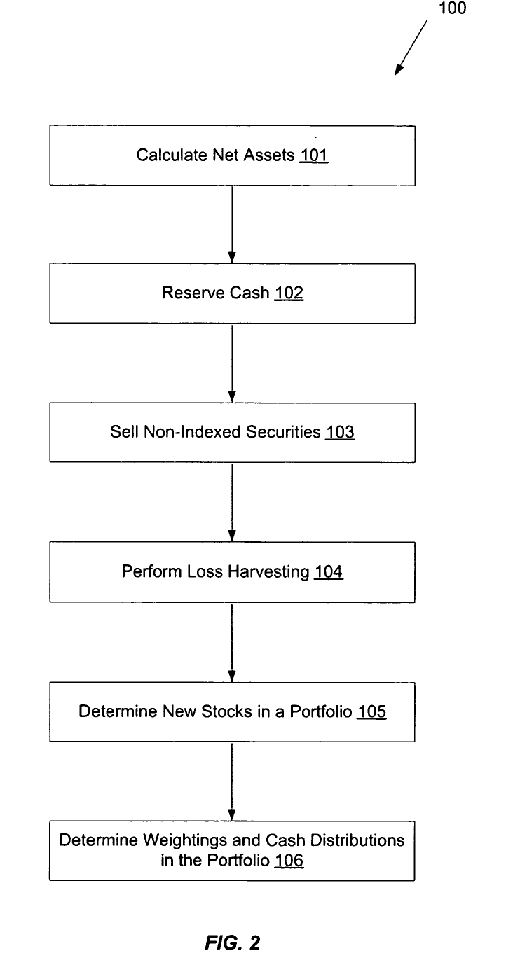

FIG. 2. shows one process embodiment for selecting and indexing stocks.

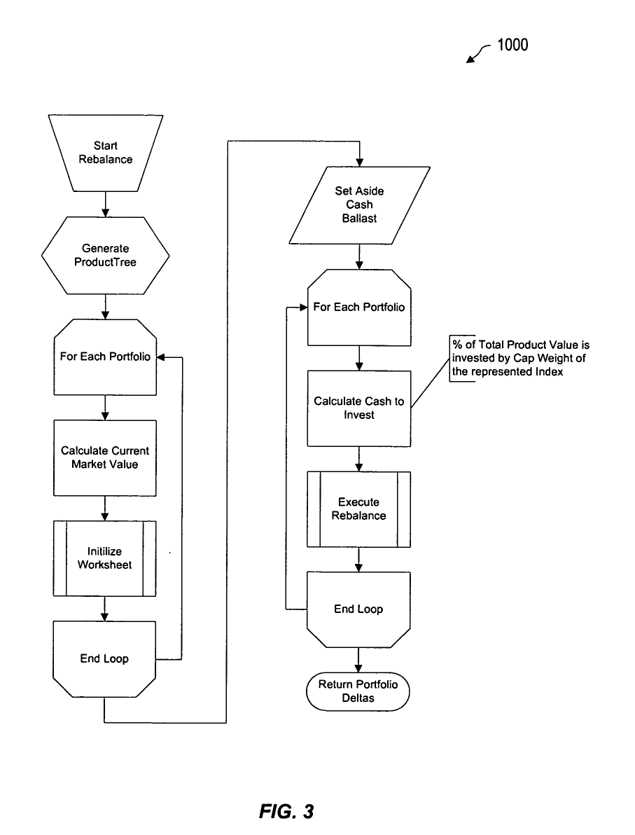

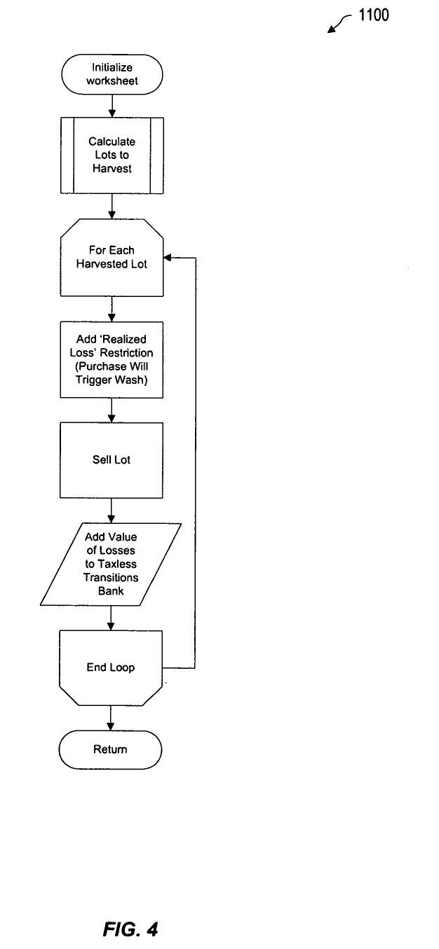

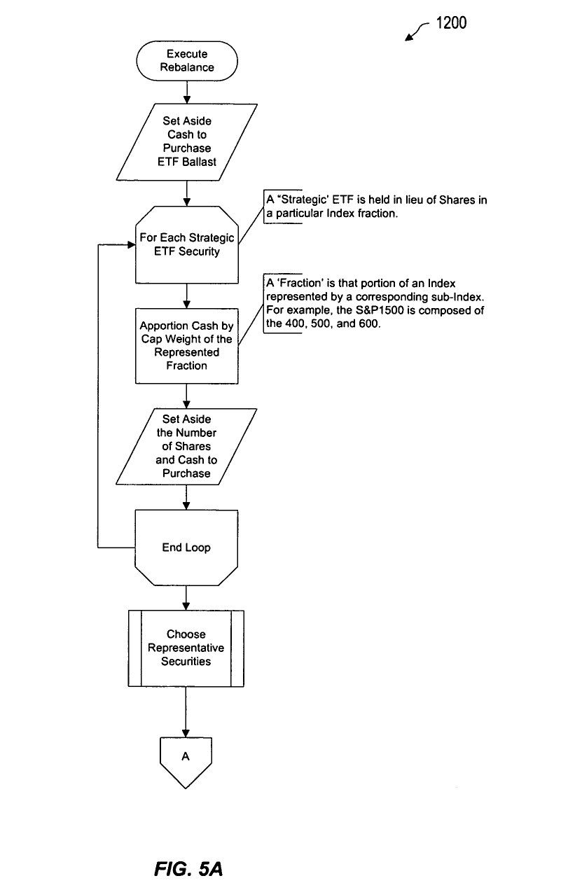

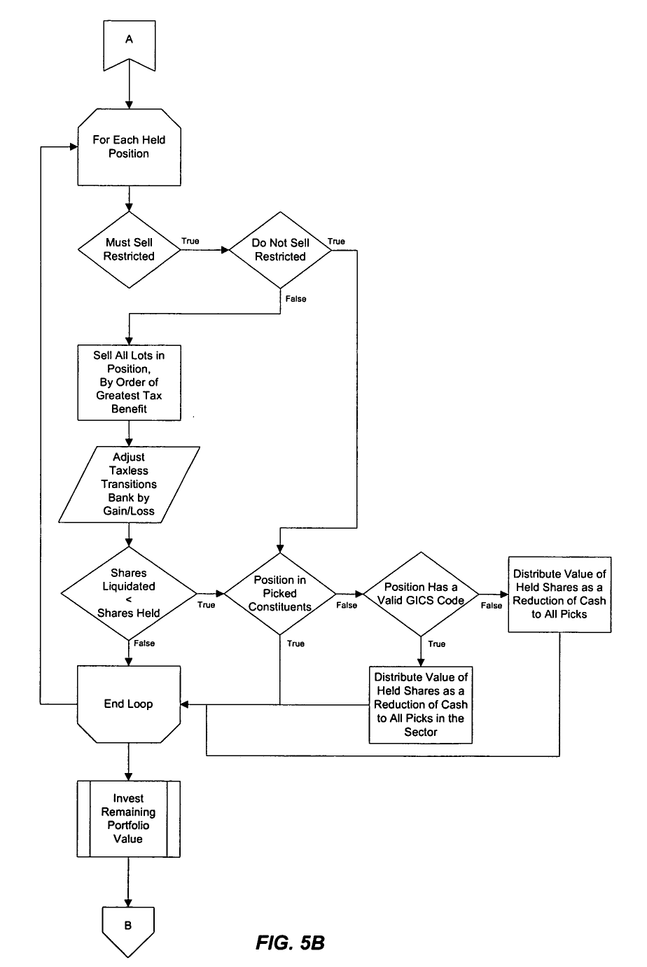

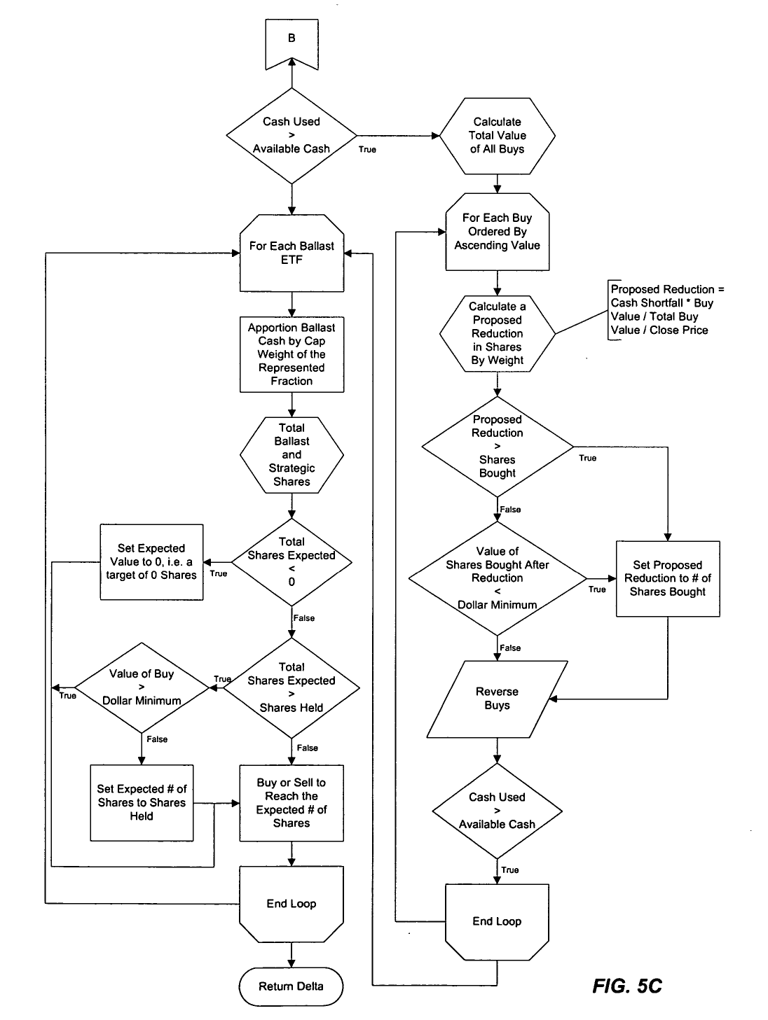

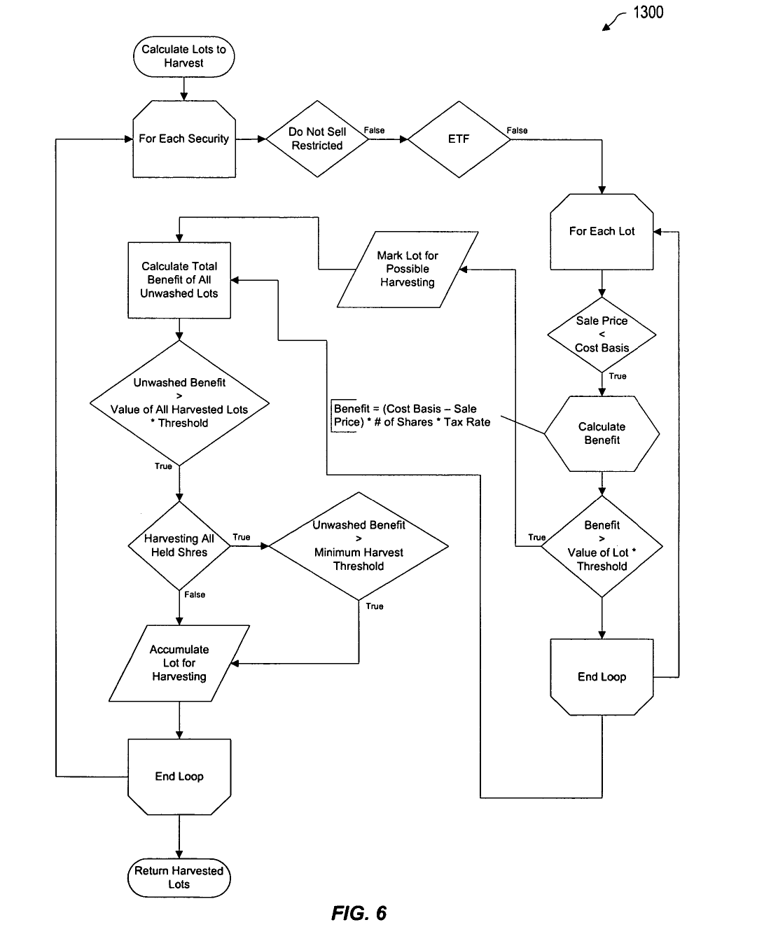

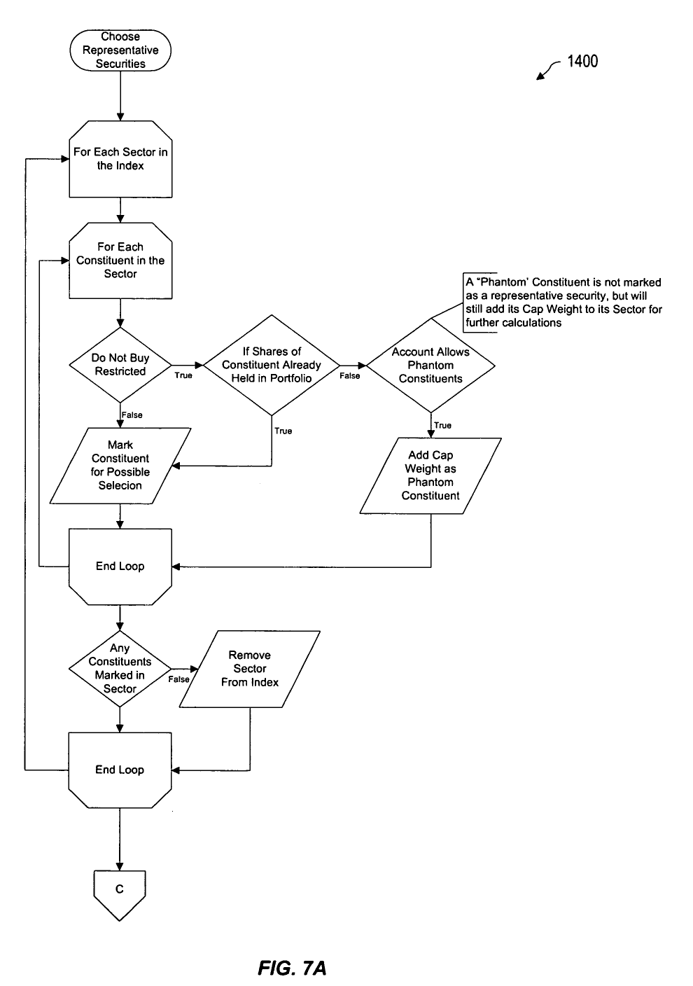

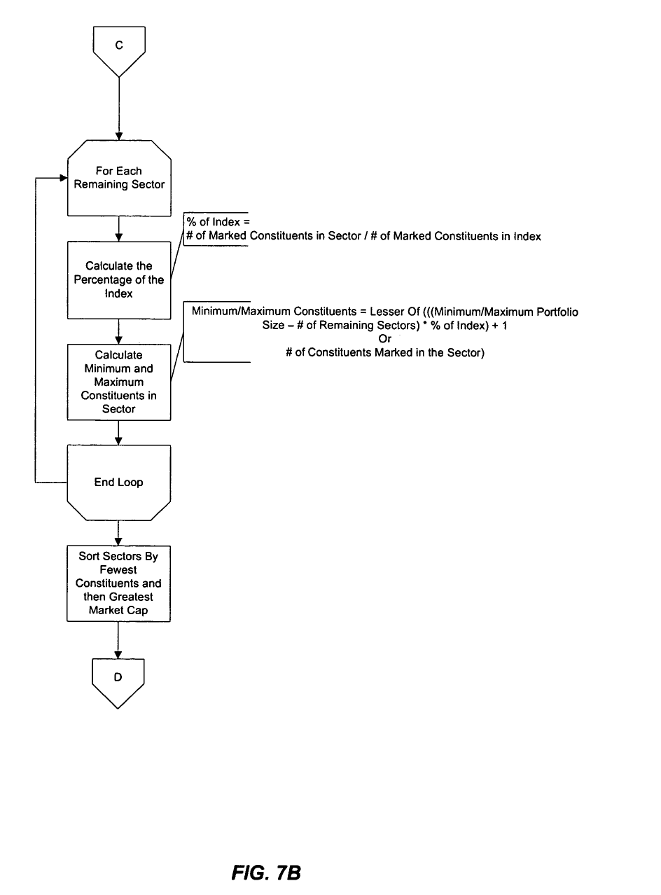

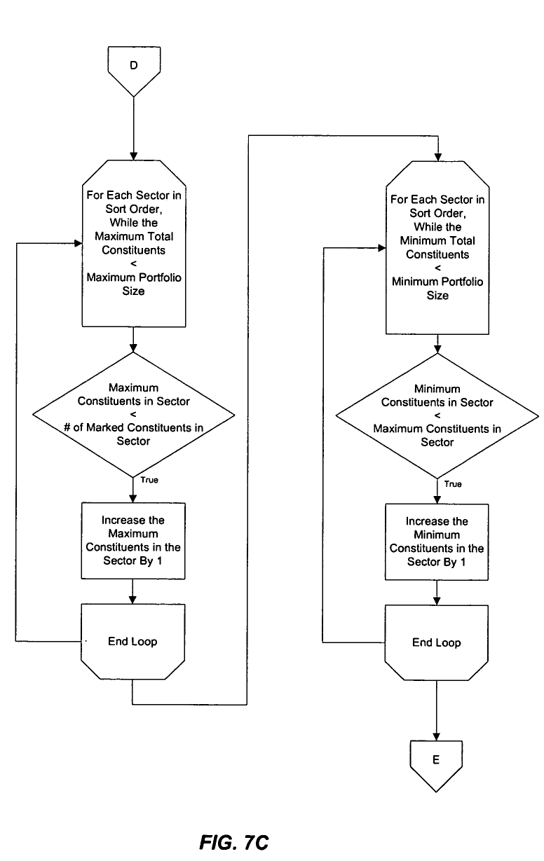

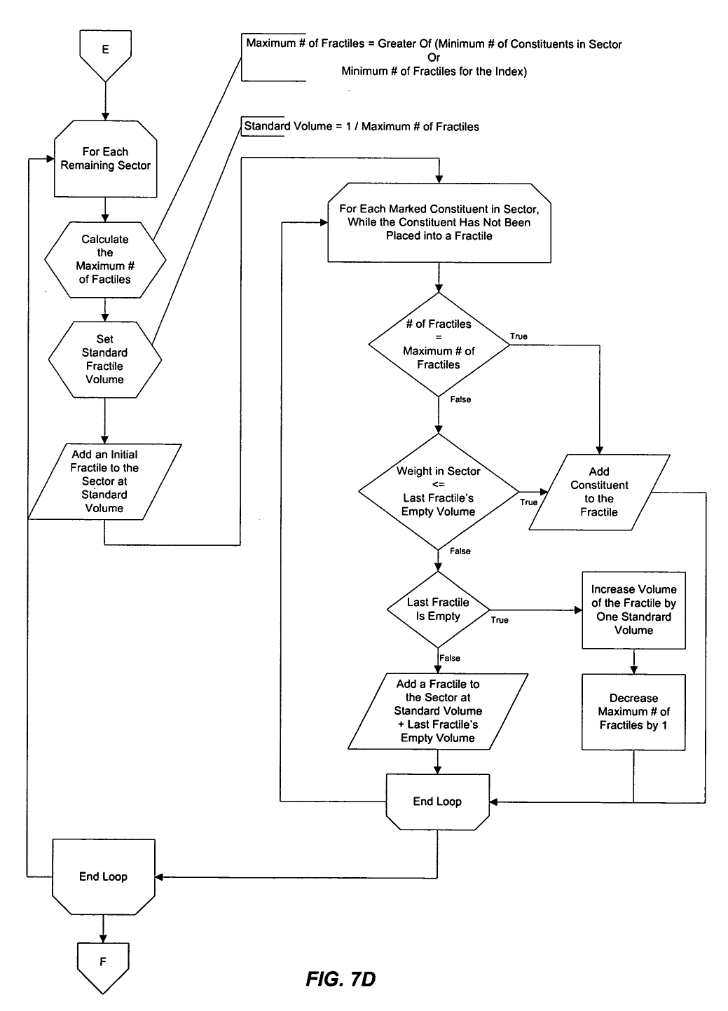

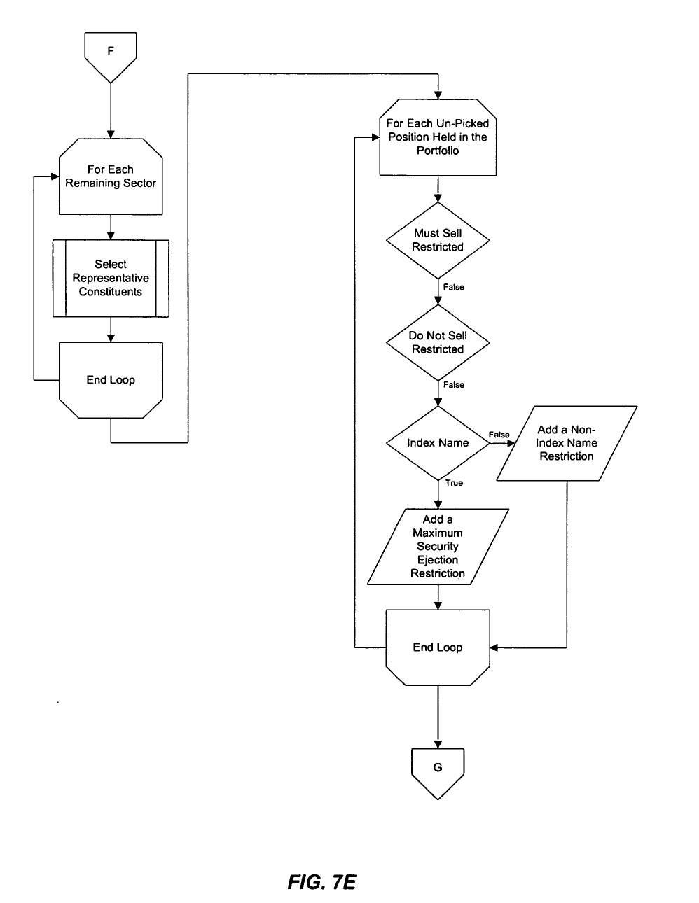

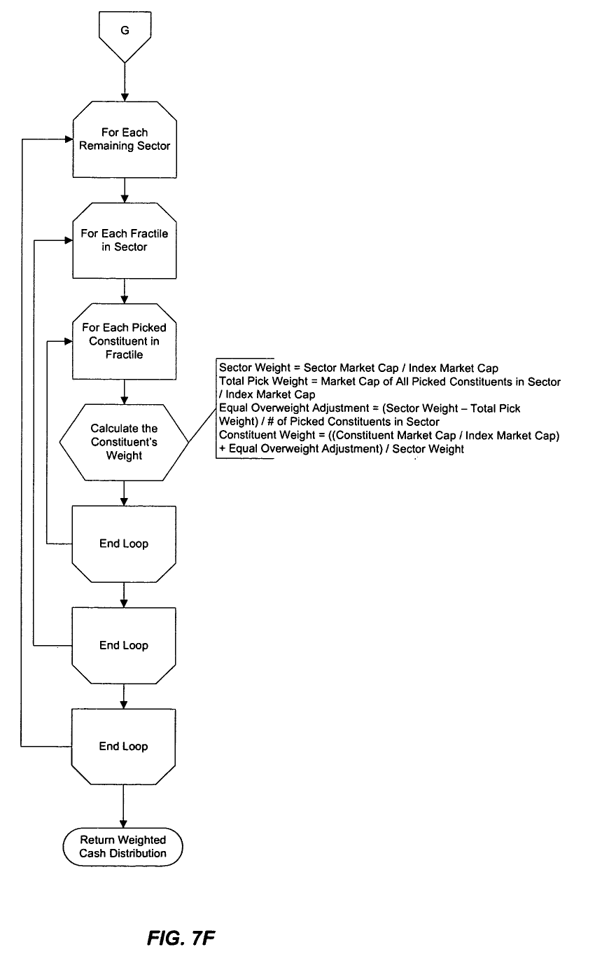

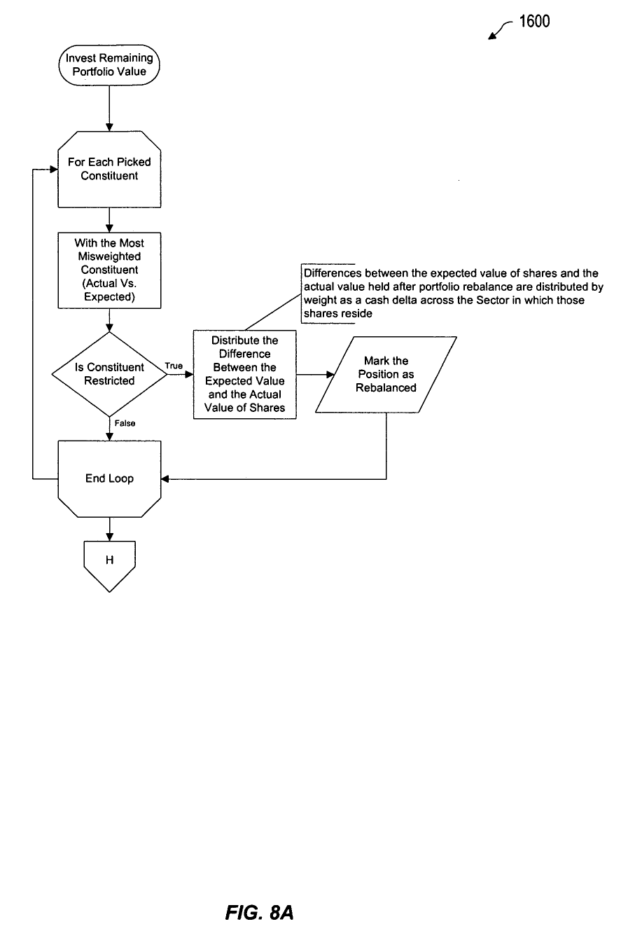

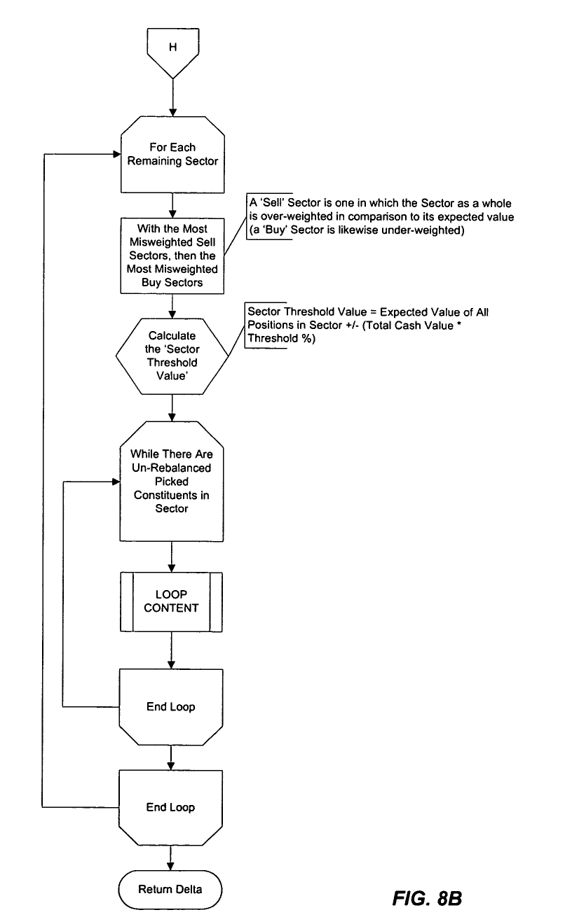

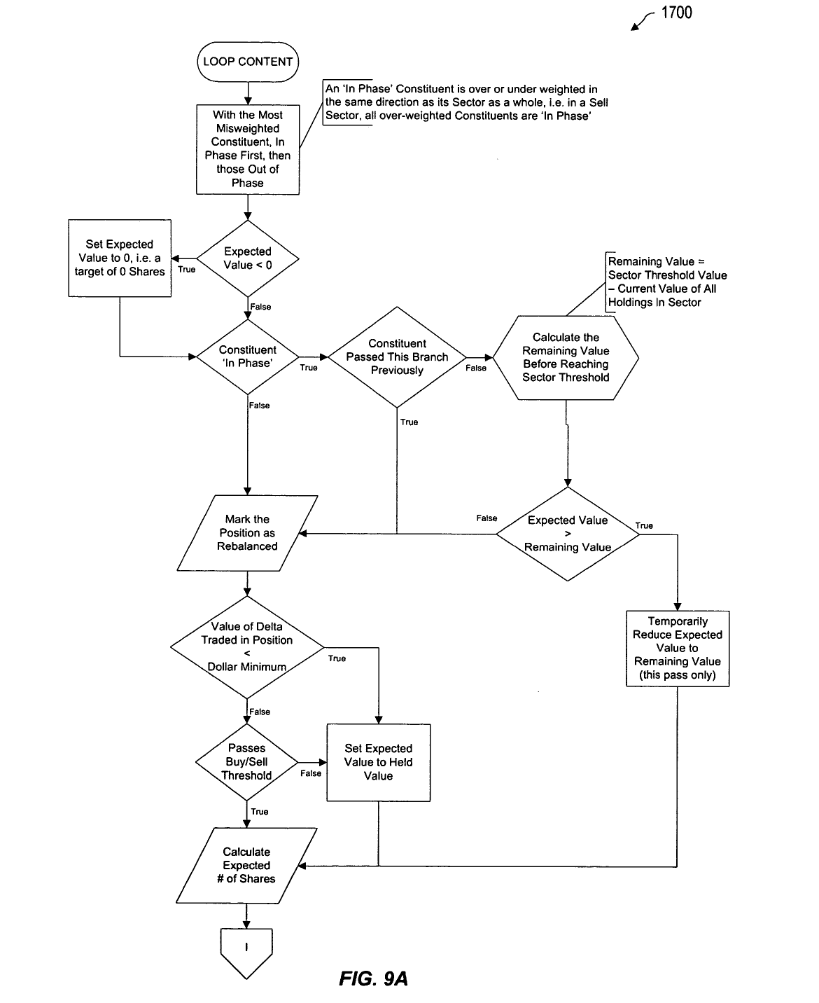

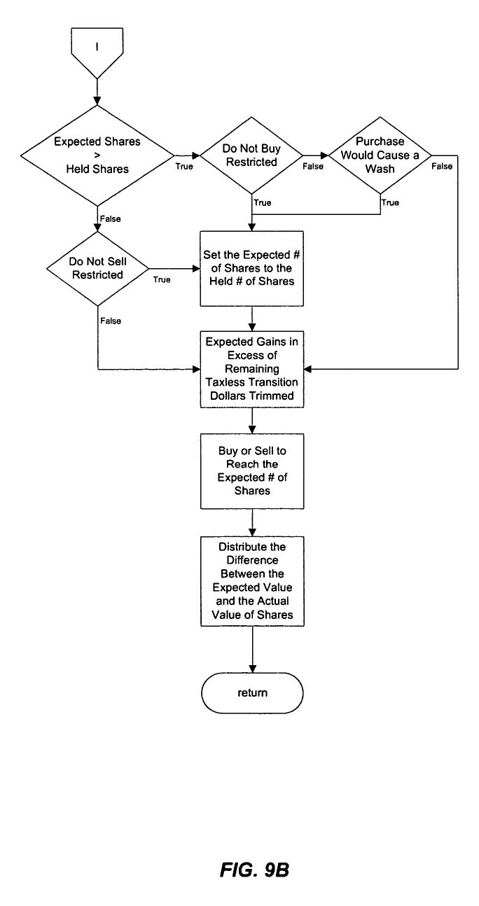

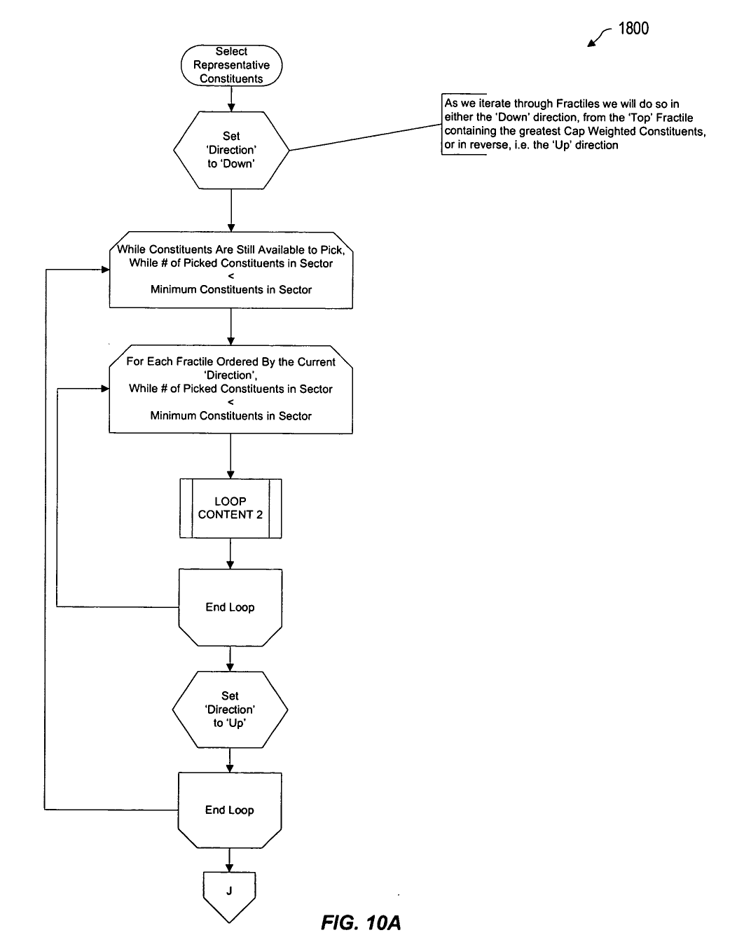

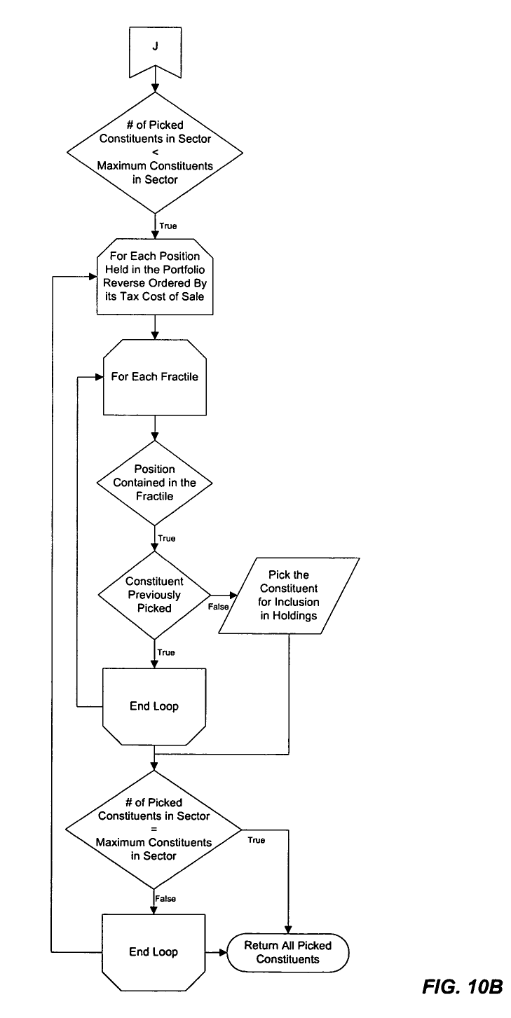

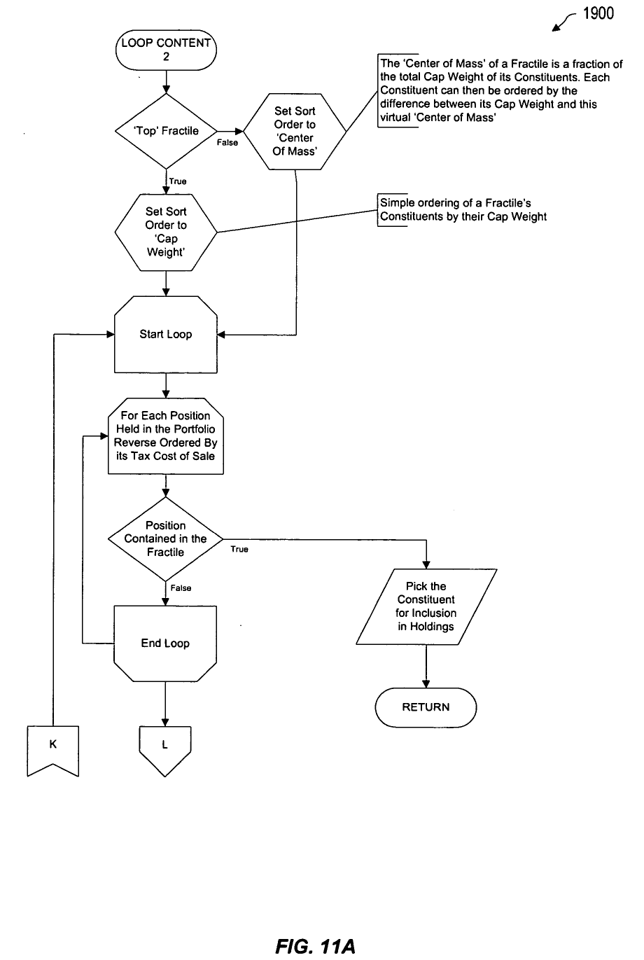

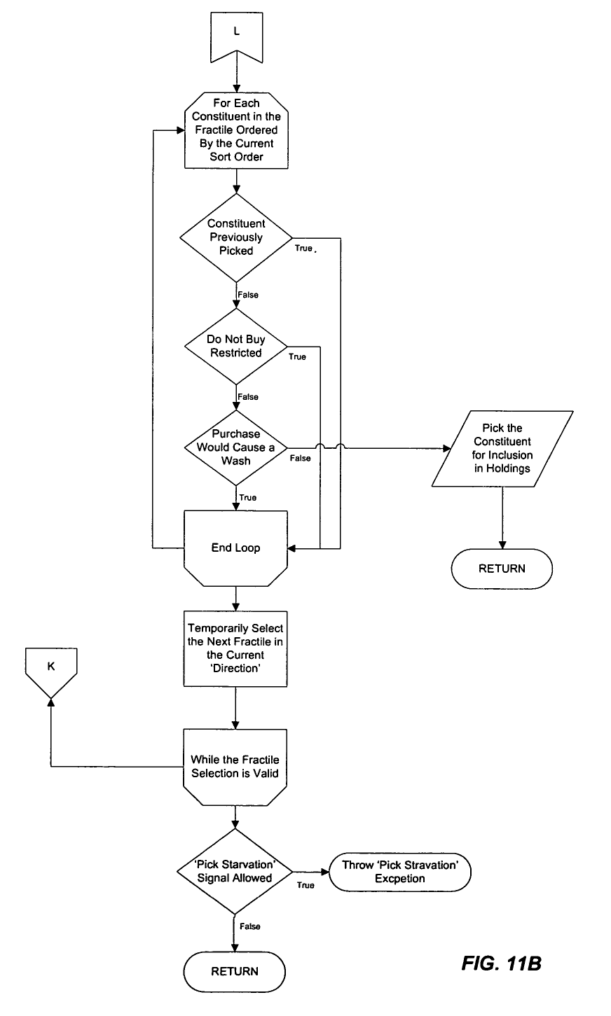

FIG. 3, FIG. 4, FIG. 5A, FIG. 5B, FIG. 5C, FIG. 6, FIG. 7A, FIG. 7B, FIG. 7C, FIG. 7D, FIG. 7E, FIG. 7F, FIG. 8A, FIG. 8B, FIG. 9A, FIG. 9B, FIG. 10A, FIG. 10B, FIG. 11A and FIG. 11B illustrate an embodiment of processes for selecting and manage securities.

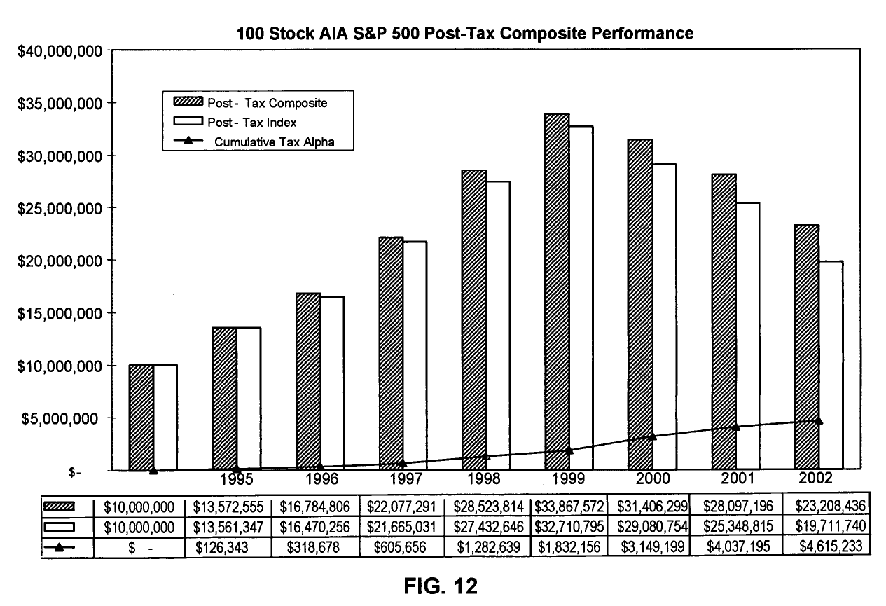

FIG. 12 illustrates tax savings obtained.

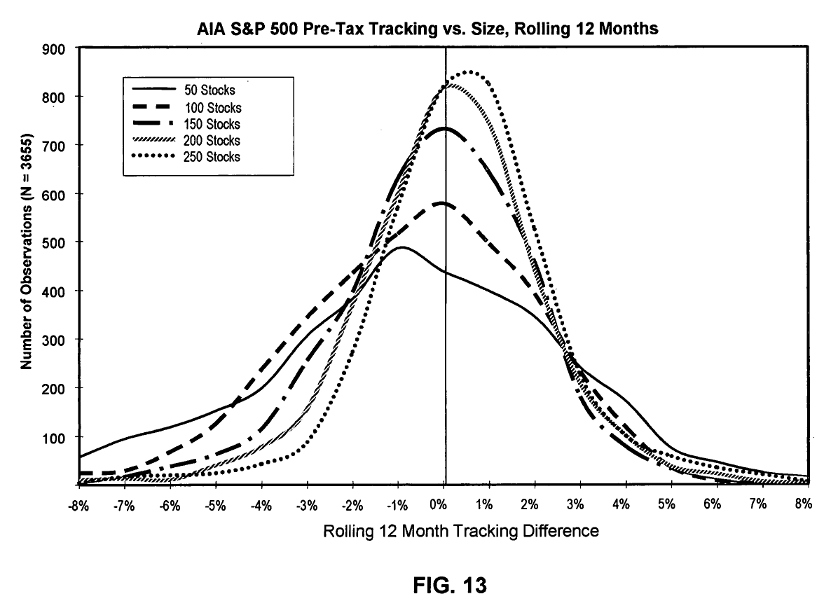

FIG. 13 illustrates tracking differences.

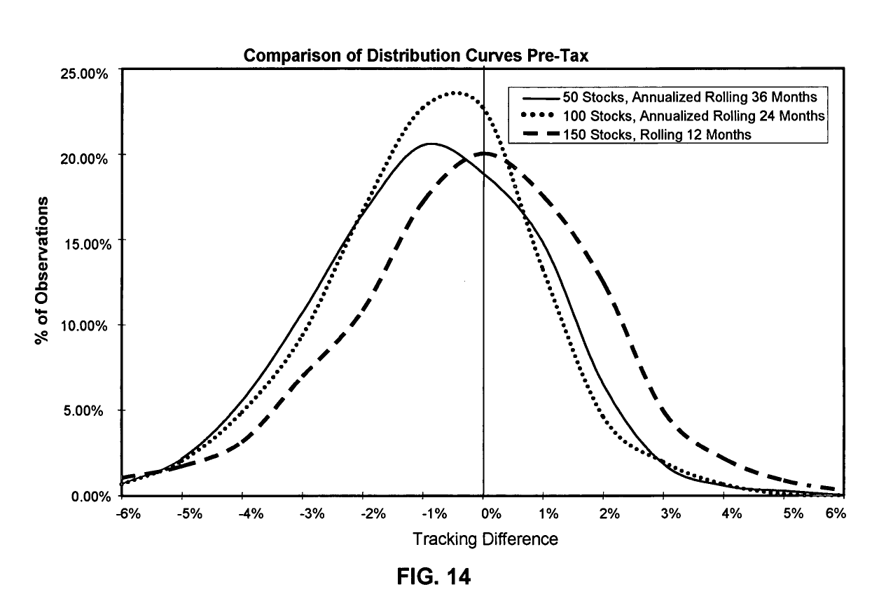

FIG. 14 illustrates distribution curves pre-tax.

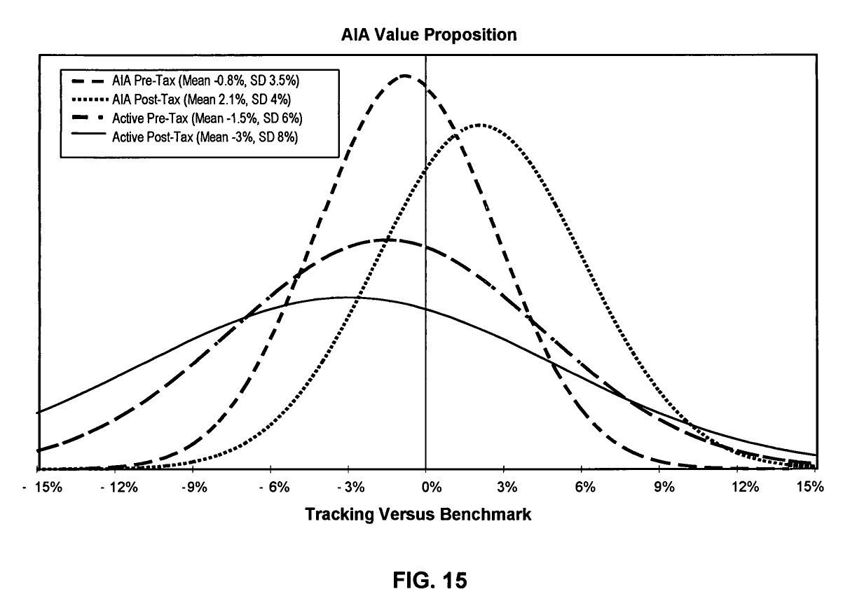

FIG. 15 illustrates benefits of stock selection and indexing according to the teachings herein.

### DESCRIPTION OF PREFERRED EMBODIMENTS

FIG. 1 shows a stock selection and indexing system 10 that applies principles of stock indexing while providing customization and tax management capabilities. System 10 is shown in an exemplary architecture that includes a server 12. Server 12 has stock selection and indexing software 14, a processor 16 and a database 18. A remote computer 20 may connect with server 12 through a network 22 (e.g., the Internet) such that a user at computer 20 may initiate and run software 14. For example, processor 16 responds to requests from network 22 to initiate and run software 14. Results from software 14 may be stored locally within database 18 or communicated over network 22 to computer 29, for example.

Server 12 may also connect with remote databases 24 that provide, for example, information (e.g., price) regarding traded securities on the stock exchange. Databases 24 may connect to server 12 through a network 26 (e.g., the Internet).

Server 12 may also connect with a management computer 28, through network 30 (e.g., a local area network), which may be used to update software 14, for example.

In an example of operation, system 10 provides selection and indexing of securities in response to user requests at computer 20. Through separately managed accounts, each such user (investor or client) may utilize system 10 to manage direct ownership of securities, customizing stock portfolios to individual needs and preferences while managing taxes. As described in more detail below, tax-management strategies may be employed to shelter gains and harvest losses to increase after-tax returns.

Indexing employed by system 10 may serve to maximize market exposure while minimizing portfolio risk, to match performance of a particular index by investing in all, or a subset of, securities within the targeted index. System 10 may therefore build portfolios that provide a pre-tax return similar to a selected benchmark that is consistent with requested customization and tax management.

Through system 10, stocks may be allocated and selected by a stratified sampling within a sector. The selected stocks may then be equally overweighted, thus avoiding overly-large active bets on one stock versus another. Loss harvesting and rebalancing may be performed at quarter end dates. If the portfolio holds a security that is deleted from the index, additional rebalancing may occur on that date. Both loss harvesting and rebalancing may be controlled by thresholds.

FIG. 2 shows a process 100 for allocating and selecting securities. Process 100 is for example implemented by software 14, FIG. 1. Briefly, in step 101, net assets are calculated. In step 102, cash is reserved in a buffer. An example of step 102 is to reserve the cash for exchange traded funds (EFTs). In step 103, non-indexed securities are sold. In step 104, loss harvisting is performed. Step 104 is for example implemented when stock prices decline by X% or more; for example X is five (5).In step 105, new stocks are determined for a portfolio. In step 106, weightings (e.g., equal overweighting) and cash distributions are set in the portfolio.

By implementing process 100, a portfolio may continue to track an index despite the sale securities that were originally desired but which can no longer be purchased due to wash sale restrictions. Accordingly, through system 10 an initial portfolio may be constructed such that, if harvested, there would be suitable securities available to minimize tracking differences to the index. For example, an initial portfolio with the largest stocks may track the index reasonably well, but, upon harvesting, a porfolio is createed with smaller stocks.

Additional exemplary detail of steps 101-106 are now described. In step 101, Net Assets are the sum of the current market value of securities and cash in a portfolio. The cash component includes all dividends earned during the period (applies only to existing portfolios). For initial portfolios, the net assets may use a starting value of $100,000.

In step 102, accounts may hold reserve cash for fees (e.g., 1% of portfolio value) and/or for ETFs, for example. Using ETFs results in lower active risk (because ETFs nearly track an index perfectly) but will also result in lower tax alpha. Each percentage increase in ETFs reduces the standard deviation of tracking differences by the same percentage, but also reduces the tax alpha by a similar percentage. So, for example, if a portfolio without ETFs has a standard deviation (active risk) of 3.0% and an average tax alpha of 2.0%, holding ETFs at 10% of the portfolio reduces the active risk to about 2.7% and reduces the tax alpha to about 1.8%. System 10 and/or process 100 by therefore reserve cash for ETFs for any of the following three purposes: to create, by proxy, a tracking portfolio with substantially fewer stocks than the benchmark's 1500; to decrease tracking differences, for example by holding 10% of the portfolio in ETFs; and/or to manage cash.

In step 103, once cash and ETF balances are reserved, non-index securities are sold. This is customizable if, for example, a user requires only tax-free transitioning or restricts the sale of certain securities. If all non-index securities are sold as of the last day within the index, for example, closing prices and applied transaction costs of 35 basis points may be applied to represent the spread.

In step 104, securities that reach a desired loss harvesting threshold are sold. Harvesting is for example performed if sufficiently exceeding estimated costs of the trade. One exemplary threshold for harvesting occurs when the estimated tax benefit exceeded 175 basis points times the market value of the trade (this is approximately a price depreciation of 5%). The tax benefit may be estimated by multiplying the unrealized capital loss by the appropriate combined tax rate. The loss harvest threshold is met, in this example, when the tax rate x unrealized capital loss>1.75% times the market value. The tax rate may be determined per lot using long-term or short-term capital gains tax rates. If there are no securities in the portfolio (as in an initial portfolio), this step may be skipped.

In step 105, the Global Industry Classification Standard (GICS) may be used to divide the index into its ten (10) sectors. The portfolio stocks are allocated to each sector in roughly the same proportions. Mathematically, they may be adjusted to ensure that each sector has at least one stock and rounded to whole numbers as in the following algorithmic example: Initial number of stocks per sector=Round down (# stocks per sector index/# stocks in index)−(number of desired stocks in portfolio−number of sectors)+1. This algorithmic example typically results in fewer than the total desired number of stocks. The sectors may then be sorted by ascending initial number of stocks per sector and descending sector index market capitalization. One stock may be added per sector, from top to bottom, until the total number of stocks allocated reaches the total desired number; this yields the adjusted number of target stocks per sector in the portfolio, in this example.

Continuing with step 105, each sector in the index is then divided into tranches. In an exemplary embodiment, the number of tranches per sector is equal to the greater of four or the number of portfolio stocks allocated. (referred to herein as “Flex Min Bucketing”). Stocks may be sorted in descending weight within each sector, and then divided into tranches, where each tranche is split at 1 divided by the number of desired tranches. If for example five tranches are desired, the breakpoints are for every 20% in cumulative weight. Because the cumulative weight does not fall exactly on a breakpoint, only the cumulative weight less than the next breakpoint is included in the tranche. The stock where the cumulative weight is greater than the breakpoint falls into the next tranche. Hence, for example, instead of tranches at the 20%, 40%, 60%, 80%, and 100% cumulative weight marks, they may instead be at 18.8%, 38.3%, 59.6%, 78.5%, and 100% (in this example; all stocks that do not fit into the second to last tranche automatically fall into the last tranche).

Continuing with step 105, once a desired target number of stocks per sector and the associated tranches are known, stocks are selected. In selecting stocks, all stocks remaining in the portfolio after loss harvesting and selling non-index constituents are first added to the rebalanced portfolio. Each of these becomes the selected stock for their respective tranche. For example, if five stocks are desired and three remain in the portfolio after loss harvesting and selling non-index securities, they will be added to the new portfolio. If these stocks are in the first, third, and fifth tranches, additional securities will not be added into those tranches. Additional stocks may be added to the portfolio if stocks are missing from their target tranche, but extras may not be removed. In this case, a new stock would be added to the second and fourth tranches.

If additional stocks are to be added, they may adhere to the following rules. In the first tranche, the largest stock is selected (but if there is already a stock in the tranche, no new stock need be selected, so the stock in the new portfolio may not be the largest stock. If the largest stock is restricted (due to wash sale rules or client restrictions, for example), then the next largest unrestricted stock is selected. If there are no other available candidates in the first tranche (e.g., it may have only one harvested stock, or it may have all restricted stocks), then the next largest stock is chosen, regardless of how far down it needs to search in subsequent tranches. For stocks initially targeted in tranches other than the first, the stock closest to the mean of the cumulative weight of the trance may be selected. If restricted, the next closest stock may be chosen. If no stock is available in its tranche, it may look to the closest to the mean stock in the next lower tranche. If no stock is available in the last tranche, then no stock may be chosen.

Due to market movement and index reconstitution, portfolios may have multiple securities falling into the same tranche over time. For example, if five stocks are desired and three stocks remain in the portfolio, after loss-harvesting, it would appear that two more stocks would be purchased; however, more stocks may actually be purchased in this case depending on which trances the existing stocks are in. If two of the three remaining stocks are in the first trance and the third is in the third tranche, then the strategy may for example choose one new stock in each of the second, fourth, and fifth tranches, resulting in six total stocks in the new portfolio. If strict adherence to the total number of desired target stocks is maintained, more stocks may be sold (e.g., those that have shifted tranches from the prior rebalance), thereby increasing turnover and capital gains; alternatively, tranches in this case may be left unfilled, disrupting the portfolio's ability to track an index. As neither of these scenarios is desirable, the portfolio sizes may be allowed to float.

In step 106, weights the selected stocks. An incorrect weighting may cause substantial tracking differences to an index. For example, the S&P 500 and S&P Equal Weight Indexes have the same constituents, but substantial tracking error to one another. Accordingly, in step 106, portfolios are weighted to be sector neutral. For example, if Financials are 23% of the index, then they will be 23% of the portfolio. The target weight for each stock within a sector may be equal to the stock's index weight within the sector, plus an overweight. By using only a subset of the index securities in the portfolio, some or all of the selected stocks may be overweighted. The overweight amount may be the same for all stocks and determined by the sum of the security weights within a sector for those securities not chosen to be in the portfolio; this figure is then divided by the number of target stocks in the sector. For example, the sum of the index weights of the chosen securities within a sector may be 80%, leaving 20% of the weight in the sector to be equally distributed among five stocks. Thus, each of the stocks, in this example, receives 20%/5=4% overweight. If a selected stock has an index weight of 18% of a sector, its weight in the portfolio will be 22%. Likewise, if a selected stock has an index weight of 1%, its weight in the portfolio will be 5%.

A current stock may be restricted from purchasing due to wash sale rules (there may be multiple lots per stock, and only those lots that exceed threshold may be harvested), in which case no further shares may be purchased. The cash that would have been distributed to the stock may be redistributed. A priority may be to keep the cash in the same sector first and then redistribute the cash evenly amongst the other unrestricted stocks. If all stocks are restricted, then the cash may be redistributed across the other sectors.

Since stocks in the portfolio may be misweighted versus their target, buy and sell tolerances may be used to avoid excessive rebalancing. While rebalancing maintains a well-constructed index-based portfolio and manages active risk, there is a tradeoff between tracking and transaction costs. Thus, securities that are overweighted by more than 1.5% versus their target may be sold down to their target weights. Likewise, small purchases for rebalancing may be limited if they increase turnover. When securities in gain positions are sold for rebalancing purposes, they may be sold by lot in order of minimizing taxes using respective long-term or short-term tax rates and applying them to losses before gains.

It should be apparent to those skilled in the art that there are many alternatives to distributing where and how to overweight. Overweighting nonethless may provide several advantages over cap weighting or tranche weighting (e.g., setting the weight of each of 5 stocks to 20%). For example, cap weighting forces the largest absolute percentage overweight to the largest names, possibly reducing the weight of the smallest names to the point that they round to 0 or some other impractically small amount. Using tranche weighting on the other hand artificially increases the weight of the smallest names, essentially creating an equal weighted portfolios within sectors which would poorly track a cap weighted index.

FIG. 3, FIG. 4, FIG. 5A, FIG. 5B, FIG. 5C, FIG. 6, FIG. 7A, FIG. 7B, FIG. 7C, FIG. 7D, FIG. 7E, FIG. 7F, FIG. 8A, FIG. 8B, FIG. 9A, FIG. 9B, FIG. 10A, FIG. 10B, FIG. 11A and FIG. 11B illustrate another embodiment of processes suitable to select and manage securities; such processes are for example implemented by system 10 of FIG. 1, such as through operations by software 14. FIG. 3 shows a rebalancing process 1000. FIG. 4 shows a harvesting process 1100. FIG. 5A-5C shows a rebalancing process 1200. FIG. 6 shows a lot harvesting process 1300. FIG. 7A-7F show a stock selection process 1400. FIG. 8A-8B show an invest remaining portfolio value process 1600. FIG. 9A-9B show a loop content process 1700. FIG. 10A-10B show a select representative constituents process 1800. FIG. 11A-11B show a loop content two process 1900.

BACKTEST EXAMPLE

The following describes a backtest which confirms delivery of superior, after tax performance versus the S&P 500 by applying tax loss harvesting on an index-based account generated by system 10 and employing processes such as described in connection with FIG. 1-15. While index funds tend to be tax efficient by their nature of low turnover, their after tax returns still tend to be less than their pre-tax returns. But using the above-descrived methodology (described in connection with FIG. 1 and 2, for example) results in after tax returns that are greater than pre-tax returns.

The benchmark results utilized portfolios with 50, 100, 150, 200, and 250 initial stocks, 1% cash holdings, and include estimated transaction costs of 35 basis points on all trades. They do not include additional wrap or management fees.

This backtest used the S&P 500 as the benchmark. Portfolios were run beginning Dec. 31, 1994 through Dec. 31, 2002 with a new portfolio starting each month, yielding 96 portfolios and 3655 rolling twelve-month observations: The portfolio beginning Dec. 31, 1994 has 85 rolling twelve-month periods, beginning Jan 31, 1995 has 84 rolling twelve-month periods, and so on. Table 1 shows these results for any given twelve month period:

TABLE 1
Rolling 12 Month periods (out of 3655 observations):

| | 50 Base | 50 Stocks | 100 Stocks | 150 Stocks | 200 Stocks | 250 Stocks |
|---|---|---|---|---|---|---|
| Pre-Tax | | | | | | |
| Average Tracking Difference | 0.16% | −0.81% | −0.61% | −0.17% | 0.14% | 0.47% |
| Median Difference | 0.13% | −0.62% | −0.45% | −0.08% | 0.20% | 0.46% |
| Standard Deviation | 3.21% | 3.54% | 2.61% | 2.16% | 2.08% | 2.07% |
| Most Underperforming 12 Month Period | −11.10% | −15.61% | −9.99% | −7.63% | −9.76% | −9.56% |
| Most Overperforming 12 Month Period | 9.57% | 10.28% | 9.27% | 11.28% | 8.59% | 9.62% |
| Probability of Underperforming > 0.5% | 42.05% | 51.63% | 49.03% | 41.45% | 34.97% | 28.48% |
| Probability of Underperforming > 3.5% | 11.35% | 19.53% | 13.65% | 6.43% | 4.24% | 3.01% |
| Probability of Underperforming > 5.5% | 4.46% | 9.96% | 3.72% | 1.56% | 1.01% | 1.18% |
| Post-Tax | | | | | | |
| Average Tracking Difference | −0.75% | 2.11% | 2.57% | 2.99% | 3.38% | 3.70% |
| Median Difference | −0.65% | 2.28% | 2.44% | 2.63% | 2.87% | 3.11% |
| Standard Deviation | 3.20% | 4.03% | 3.30% | 3.13% | 3.24% | 3.35% |
| Most Underperforming 12 Month Period | −12.96% | −14.17% | −7.86% | −4.13% | −4.77% | −6.74% |
| Most Overperforming 12 Month Period | 8.11% | 15.14% | 16.09% | 20.06% | 19.10% | 20.18% |
| Probability of Underperforming > 0.5% | 52.37% | 24.57% | 17.26% | 9.74% | 6.68% | 4.46% |
| Probability of Underperforming > 3.5% | 16.63% | 8.15% | 2.65% | 0.25% | 0.25% | 0.19% |
| Probability of Underperforming > 5.5% | 6.89% | 3.34% | 0.33% | 0.00% | 0.00% | 0.08% |
| Tax Alpha | | | | | | |
| Average Tax Alpha | −0.91% | 2.92% | 3.18% | 3.16% | 3.24% | 3.24% |
| Median Tax Alpha | −1.05% | 2.48% | 2.82% | 2.59% | 2.62% | 2.60% |
| Standard Deviation | 1.14% | 3.00% | 2.67% | 2.46% | 2.34% | 2.31% |
| Worst Case Tax Alpha | −5.28% | −2.58% | −1.84% | −0.52% | 0.29% | 0.02% |
| Best Case Tax Alpha | 2.55% | 16.31% | 15.45% | 15.99% | 15.70% | 14.81% |
| Probabilityof Tax Alpha > 0.5% | 12.28% | 73.21% | 84.51% | 95.76% | 98.91% | 99.21% |
| Tracking Statistics | | | | | | |
| R-Squared | 97.53% | 97.09% | 98.35% | 98.87% | 98.99% | 99.05% |
| Correlation | 0.9876 | 0.9853 | 0.9917 | 0.9943 | 0.9949 | 0.9953 |
| Beta | 0.9966 | 1.0074 | 0.9922 | 0.9787 | 0.9698 | 0.9589 |

50 Base: 50 Stocks, No Loss Harvesting, No Transaction Costs, 1% Cash
The other cases use loss harvesting, 35 bps transaction costs, 1% Cash

The following observations and findings are determinable from the backtest:
Excluding transaction costs and loss harvesting, a 50 stock portfolio tracks an index pre-tax with a standard deviation of 3.2%.
Increasing the number of stocks in the portfolio results in smaller tracking differences (active risk) pre-tax.
Tax alpha from loss harvesting varies substantially depending on the date of the initial investment and the subsequent market conditions.
Pre-tax active risk for a 50 stock portfolio is about 3.5%; for 100 stocks portfolios it is about 2.6% and falls to about 2% at 200 stocks.
Loss harvesting opportunities are greater in declining, volatile markets.
Tax alpha in any twelve month period may range from about −2.6% to +16.3%, with an average of 2-3%.
The probability of a tax alpha greater than 0.5% in any twelve month period is 73% for a 50 stocks, 85% for a 100 stocks, 96% for 150 stocks, and 99% for 200 and 250 stocks.
In rising markets, tax alpha may be negative due to rebalancing the portfolio with positions in capital gains.
There is a trade-off between minimizing tracking differences, maximizing tax alpha, and minimizing costs.
The strategy provides upside market gains with downside post-tax protection.
Adding ETFs to a portfolio proportionately reduces the active risk, but it also proportionately reduces the tax alpha.
Pre-tax underperformance is expected due to including transaction costs and the assumption of holding 1% in cash. Roughly 25 basis points per year are attributable to transaction costs and another 15 basis points per year for cash drag.

The “50 Base” portfolio of Table 1 shows that process 100 tracks an index closely using stratified sampling. This base case used 50 stocks with no transaction costs and no loss harvesting. Rebalancing was done quarterly for risk management purposes only. Such a portfolio track a pre-tax index with a standard deviation of 3.2% over the observed time period. The observed time period included extremely volatile markets up and down, yet the base case portfolio had an r-squared of 98%, correlation of 0.99, and a beta of nearly 1. As a point of reference, the 50 stock S&P 500 portfolio has a predicted tracking error of 2.6% using Barra as of Dec. 31, 2003.

The backtest also illustrated tradeoffs between the otherwise conflicting goals of high correlation and maximizing tax alpha. Ideally, the “best” portfolio tracks the index with perfect correlation on a pre-tax basis, while maximizing loss harvesting, and, hence, maximized after-tax returns. However, harvesting losses require portfolio rebalancing, thereby incurring transaction costs and portfolio weighting to something less than ideal (if, for example, minimizing pre-tax tracking were the only concern). This in turn may lead to greater tracking variances. If priority is placed on minimizing tracking differences, it would require holding more stocks and forgo loss harvesting, thus reducing post-tax alpha.

Parameters may therefore be selected to balance these opposing objectives; these parameters include, but are not limited to: sell tolerances, buy tolerances, loss harvesting thresholds, transaction costs, cash balances, ETF holding levels, initial number of stocks, and tax rates.

Note that the backtest included transaction costs (spread) of 35 basis points for every trade, and assumed holdings of about 1% in cash to avoid overdrawing the accounts and to reserve for payments of fees. Further, the backtest used only a whole number of shares. The backtest was therefore realistic of actual transactions.

In the backtest, portfolios of all sizes outperformed the index after tax if loss harvesting is used, yet they still tracked the index (pre-tax) with high r-squared and correlation figures and betas close to 1.

Indexing by system 10, FIG. 1, and process 100, FIG. 2, thus follows the market on a pre-tax basis (less transaction costs and cash drag), yet outperforms on a post-tax basis by tax loss harvesting. Loss harvesting involves realizing capital losses by selling securities that have declined in value. These losses may be used to offset capital gains inside or outside the portfolio for tax purposes. The end result is tax savings up to for example 41% on the amount of the realized capital loss. That is, for every $10,000 in capital losses realized, a user of system 10 may save roughly $4100 in taxes. The money raised from loss harvesting is used to buy new securities, or additional shares of existing securities, to construct a new index-based portfolio while obeying wash sale rules and user-specific restrictions.

Note that loss harvesting benefits do not eliminate taxes permanently, but rather defers the taxes into the future because proceeds generated from loss harvesting are reinvested into the portfolio, lowering the cost basis. Maximum benefit is realized if assets are passed on to an heir since they will receive a “step up” value in cost basis (i.e., the cost basis is reset to current market values, erasing unrealized capital gains). This is an enhanced version of a classic buy-and-hold strategy, which has a tangible tax benefit by deferring the realization of capital gains for as long as possible. But unlike a standard buy-and-hold strategy, loss harvesting actively realizes losses.

The backtest used data from Compustat's Expressfeed from S&P; but this data is somewhat different than the published index data. The main differences are in the shares outstanding and treatment of corporate actions. Expressfeed updates shares outstanding as they obtain the information. However, the S&P indexes only make immediate changes in shares outstanding when they are greater than 5%, to avoid excessive turnover from a practitioner's point of view. This timing difference creates artificial tracking errors in the backtest. With regard to corporate action, when an index constituent (e.g., Palm) spins off part of its company, a real shareholder will receive value (usually in the form of shares) for the new company (e.g., PalmSource). In Expressfeed data, the share price of the parent security falls by the value of the spinoff, but the value of the new security is not accounted for, making the portfolio appear to lose value. To adjust for this in the backtest, such spinoffs were treated as a dividend to the parent company. Not all such situations could be accounted for, however; for that reason, calculated indices trend slightly negative over time.

A shadow portfolio is a fully-replicating index portfolio, consisting of all stocks in the benchmark in their respective weights (essentially an index fund). All index additions and deletions were accounted for on the effective date of their changes. In the following description, shadow portfolios were allowed to hold fractional shares in order to avoid misweights due to rounding. All dividends and splits were captured and accounted for.

There are two main reasons in creating and using shadow portfolios as a benchmark. First, they are used to most accurately calculate an after-tax benchmark (no indexes currently report their performance figures after-tax), and, second, to have the capability to provide custom pre- and post-tax benchmark returns. For example, S&P does not construct an S&P 500 Ex-Technology or S&P 500 Ex-Tobacco index. When such a portfolio is needed, system 100 may manage and benchmark the portfolio.

For the most part, the shadow portfolios tracked the index total returns within 50 basis points due to a few small differences in data. As explained earlier, the main differences are the timing of shares outstanding updates and the treatment of spinoffs. Shadow benchmarking was used instead of the published index because it is most consistent with the data available for the backtest. Additionally, the shadow provides the most accurate representation of a benchmark for calculating post-tax comparable performance and subsequent tax alpha. While the shadow portfolios did not perfectly match the published index returns due to the limitations of the data, the backtested strategies were calculated based on the same data. Thus, the results of the backtest must only be compared to the performance of the shadow portfolios, not the published index.

During the backtest, on a pre-tax basis, portfolios were measured monthly for beginning to ending market value to calculate pre-tax returns. Transaction costs of 35 basis points were applied to all trades. On a post-tax basis, portfolio performance was calculated as the difference between the current period's after tax value and the prior end of month's pre-tax market value. The current month's after tax value was calculated by subtracting the estimated taxes from the current pre-tax value. A federal tax rate of 35% was applied to short-term capital gains. The tax rate used for dividends and long-term capital gains was 15%. Calculations also included a California tax rate of 9.3%. Combined effective tax rates were applied using the federal rate×Calif. state tax rate (1- federal tax rate) to account for the state tax deductibility for federal taxes. If there were net losses realized, this would result in negative taxes (tax savings) and higher after-tax performance. Net gains result in tax costs and lower after-tax performance. All tax benefits are applied to the portfolios in the month in which they occurred. This convention is consistent with AIMR after-tax reporting guidelines.

For purposes of the backtest, “tax alpha” (see Table 1) is defined as the difference between the post-tax tracking error and the pre-tax tracking error and may be positive or negative. Tax alpha in this definition is thus the net benefit (or cost, if negative) to the portfolio due to taxes. Pre-tax tracking error is the difference between the pre-tax performance of the portfolio and the shadow portfolio (the index as calculated). Post-tax tracking error is the difference between the post-tax performance of the portfolio and the shadow portfolio (the after-tax index, as calculated). The shadow portfolio used the same rules for applying taxes to realized capital gains/losses and dividends. Note that the shadow portfolio does not loss harvest and is representative of a full replication index fund.

In the backtest, simulated backtests were run beginning Dec. 31, 1994 (as far back as GICS codes have history) through Dec. 31, 2002. A new portfolio started at the end of each month for a total of 96 portfolios (8 years×12 portfolios/year). Simulations were run for 50, 100, 150, 200, and 250 stock initial portfolios. Returns and performance figures were measured for the composite and for the individual portfolios. Tracking differences were measured before and after tax versus the calculated index (shadow portfolio). Portfolios were loss harvested and rebalanced at calendar quarters (and when a holding was deleted from the index), use transaction costs of 35 bps per trade, have minimum purchases of $100 per trade, will sell securities with more than 1.5% in overweight, and target 1% in cash.

Measuring composite performance helps determine what the total performance is for all assets under management. Using the composite demonstrates how well short-term and long-term portfolios perform in up and down markets.

The backtest results suggest that the composite tracks the index well on a pre-tax basis. Portfolios of all sizes have high r-squares and correlation, with betas close to 1. The composites outperformed on a post-tax basis over time, though there are a few cases in single years where the composites underperformed their after-tax benchmark; these are because the tax alpha generated was not sufficient to make up for any pre-tax underperformance. The backtest composites had positive tax alpha every year for all portfolio sizes over the duration of this backtest.

Since portfolio performances in a composite offset one another, the standard deviations and range of the outliers tend to be smoothed over. Thus, the backtest considered the data two additional ways: 1) 8 full calendar year portfolios (i.e., Dec. 31, 1994-Dec. 31, 2002, Dec. 31, 1995-Dec. 31, 2002, etc.) to see how an investor would have performed if he had an initial investment at year-end, and 2) 96 individual portfolios analyzed in 3655 rolling twelve-month time periods. For full calendar years, the average portfolio has positive after-tax differences. The tax alpha generated for these portfolios more than made up for any pre-tax losses. In down markets, the outperformance post-tax tends to grow larger by actively loss harvesting. These results may be illustrated such as in FIG. 12.

As mentioned above, loss harvesting is highly dependent upon the start date of the portfolio. The full-year simulations were run with start dates of December 31 of each year rolling forward for full years though Dec. 31, 2002. Note that for a portfolio starting Dec. 31, 1994 the tax alpha is actually negative. This is due to rebalancing the portfolio (for risk management purposes) while it is predominantly has capital gain positions due to large advances in the market. Tax alpha becomes positive in later years when the market if falling. The tax alpha in those years is less than if a portfolio were to begin in a down market because the cost basis for the Dec. 31, 1994 portfolio is lower, so the market needs to fall further before the equivalent amount of tax alpha can be generated.

Because the tax loss harvest benefit is highly dependent on the inception date (and thus cost basis) of the portfolio, simulations of the backtest were also run with a new portfolio starting every monthend beginning Dec. 31, 1994 and running through Dec. 31, 2002. Using this data, performance that any individual investor might see over 12, 24, and 36 month periods was evaluated. For the time period of the data, there were 85 portfolios with 12 months or more of data, yielding 3655 data points. The portfolio beginning Dec. 31, 1994 had 85 rolling 12-month periods; the portfolio beginning Jan. 31, 1995 had 84 rolling 12-month periods and so on. There were 2701 data points with 24-month rolling periods and 1891 data points with 36-month rolling periods.

In the benchtest, it was shown that although a pre-tax portfolio may not track the pre-tax index perfectly in any given year, it will get closer on an annualized basis over time. Likewise, increasing the number of stocks in a portfolio decreases the active risk. See FIG. 13. Also, holding fewer stocks achieves the same distribution as a portfolio with more stocks if you hold it for a longer period of time. See FIG. 14. For example, the distribution curve for 50 stocks annualized over 36-month periods is very similar to that of 100 stocks annualized over 24-month periods or 150 stocks over 12-month periods. What this means is that you will eventually end up in about the same place, regardless of size, but you'll need to hold your portfolio longer with a fewer number of stocks. The longer your time horizon, the less size matters pre-tax.

The benefit of loss harvesting rises when going from 50 to 150 stocks, but then tends to flatten out, due to having suitable stocks to reinvest in after harvesting. If the portfolio gets too large, it may result in “lockup,” where there are no other stocks to buy without violating wash sale rules. See FIG. 15.

The following statistical definitions were used with the benchtest:
Beta: The measure of systematic risk of a security. Beta (or beta coefficient) is a means of measuring the volatility of a security or portfolio of securities in comparison with the market as a whole. Beta is calculated using regression analysis. A beta of 1 indicates that the portfolio's change in value will move with the market. A beta greater than 1 indicates that the portfolio's change in value will be more volatile than the market. A beta less than 1 means that it will be less volatile than the market.
Correlation: A measure that determines the degree to which two variable's movements are associated. The correlation coefficient is calculated as:

$${ρ}_{xy} = \frac{Cov ( {r}_{x} , {r}_{y} )}{{σ}_{x} {σ}_{y}}$$

The correlation coefficient will vary from −1.0 to 1.0. −1.0 indicates perfect negative correlation, and 1.0 indicates perfect positive correlation.
Standard Deviation: A measure of the dispersion of a set of data from its mean. The more spread apart the data is, the higher the deviation. In finance, standard deviation is applied to the annual rate of return of an investment to measure the investment's volatility (risk).One standard deviation away from the average accounts for somewhere around 68 percent of the annual returns in the time period. Two standard deviations away from the mean account for roughly 95 percent of the annual returns. And three standard deviations account for about 99 percent of the annual returns.
R-Squared: A statistical measure that represents the percentage of a portfolio's movements that are explained by movements in a benchmark index. R-squared values range from 0 to 1. A higher R-squared value will indicate a more useful beta figure. A low R-squared means you should ignore the beta.

1. The method of determining an investment portfolio, comprising:
selecting a target index of securities;
dividing the target index into a plurality of sectors;
determining a target number of securities for the investment portfolio;
determining representative securities for each of the sectors;
populating the investment portfolio with the representative securities, wherein substantially the target number of securities exists within the investment portfolio.

2. The method of claim 1, wherein the step of determining comprises determining percentages of securities in the investment portfolio based upon a number of securities and market capitalization of target index securities of each of the sectors.

3. The method of claim 1, further comprising dividing funds into reserved funds and investment finds; and
purchasing the sampled securities using the investment funds.

4. The method of claim 3, further comprising making a subset of the reserved funds readily available to cover investment costs.

5. The method of claim 3, further comprising investing a subset of the reserved funds in a security performing substantially identically to the target index.

6. The method of claim 1, wherein the step of determining a target index comprises selecting one of (a) the S&P 500 or any other index and (b) another known stock index.

7. The method of claim 5, wherein the step of investing a subset of the reserved funds comprises investing in exchange traded funds.

8. The method of claim 1, wherein the step of dividing the target index comprises utilizing the Global Industry Classification Standard.

9. The method of claim 1, further comprising the step of modifying the target index with an investment objective.

10. The method of claim 1, wherein the step of selecting a target index comprises the step of creating a target index based on an investment objective.

11. The method of claim 1, wherein the step of dividing the target index comprises modifying securities within each sector based upon an investment objective.

12. The method of claim 1, wherein the step of dividing the target index into sectors comprises formulating sectors.

13. The method of claim 1, wherein the step of determining representative securities comprises:
subdividing each sector into buckets; and
determining securities from the buckets based upon, at least, one or more attributes of the securities.

14. The method of claim 18, wherein the step of determining securities from the buckets comprises redefining a number of securities for the buckets.

15. The method of claim 1, wherein the step of determining representative securities for each of the sectors comprises the step of selecting a largest security not previously selected.

16. The method of claim 1, further comprising rebalancing the investment portfolio to correct discrepancies in tracking the target index.

17. The method of claim 21, the step of rebalancing comprising the step of selling an overweight security.

18. The method of claim 21, the step of rebalancing comprising applying reserved funds to an underweight security.

19. A system for determining an investment portfolio, comprising:
means for selecting a target index of securities;
means for dividing the target index into a plurality of sectors;
means for determining a target number of securities for the investment portfolio;
means for determining representative securities for each of the sectors;
means for populating the investment portfolio with the representative securities, wherein substantially the target number of securities exists within the investment portfolio.

20. The software product comprising instructions, stored on computer-readable media, wherein the instructions, when executed by a computer, perform steps for determining an investment portfolio, comprising:
instructions for selecting a target index of securities;
means for dividing the target index into a plurality of sectors;
means for determining a target number of securities for the investment portfolio;
means for determining representative securities for each of the sectors;
means for populating the investment portfolio with the representative securities, wherein substantially the target number of securities exists within the investment portfolio.
